(19) United States
(12) Patent Application Publication
(10) Pub. No.: US 2012/0186965 A1
(43) Pub. Date: Jul. 26, 2012

(54) Touch-Sensitive Switch

(75) Inventor: David Zieder, Sciez (FR)

(73) Assignee: Nicomatic SA, Bons-en-Chablais (FR)

(21) Appl. No.: 13/496,285

(22) PCT Filed: Sep. 14, 2010
(86) PCT No.: PCT/EP2010/063421

§ 371 Date: Apr. 13, 2012

(30) Foreign Application Priority Data
Sep. 15, 2009 (FR) FR0904397

(51) Int. Cl. H01H 1/10

(52) U.S. Cl. 200/513

(57) ABSTRACT

The invention relates to a touch-sensitive switch, characterized in that it includes at least one dome (7, 107, 207a, 207b), at least one disk (11), and at least one insulator (13, 213a, 213b) arranged between said dome (7, 107, 207a, 207b) and said disk (11), such that the peripheral portions of said dome (7, 107, 207a, 207b) and said disk (11) are each in contact with a surface of said insulator (13, 213a, 213b), said insulator (13, 213a, 213b) having a central opening (27) so as to enable contact between said dome (7, 107, 207a, 207b) and said disk (11) when subjected to a force bringing the same closer to one another.

The invention concerns a touch-sensitive switch.

In a known manner a touch-sensitive switch comprises two conductive members between which electrical continuity is established when the switch is subjected to mechanical activation, for example by one or more fingers of a user, and the switch transmits tactile feedback to the user.

At present, touch-sensitive switches must respond to certain dimensional constraints and be smaller and smaller so as to have a small overall size.

For example, for diverse security, financial and other applications there is a requirement to incorporate such touch-sensitive switches in thin supports similar to bank cards.

Given the dimensions of such cards, the touch-sensitive switches must have a small thickness of the order of 0.4 mm.

Known touch-sensitive switches generally do not meet this dimensional criterion, however.

Thus an objective of the invention is to alleviate this drawback of the prior art by proposing a thin touch-sensitive switch guaranteeing sufficient tactile feedback to the user.

To this end, the invention provides a touch-sensitive switch characterized in that it includes at least one dome, at least one disk, and at least one insulator disposed between said dome and said disk, such that the peripheral portions of said dome and said disk are each in contact with one side of said insulator and thus face each other on respective opposite sides of said insulator, said insulator having a central opening so as to enable contact between said dome and said disk when they are subjected to a force bringing them closer together.

In this form, said switch guarantees tactile feedback and has a small thickness facilitating its integration into or onto thin supports with no increase in overall size.

Said switch may further have one or more of the following features, separately or in combination:
said switch further includes a spacer configured to be disposed between said switch and a support of said switch, to improve the operation of said switch;
the spacer is an insulative spacer;
said switch includes two connecting members configured to cooperate with a respective associated connecting area of the support of said switch;
the spacer is a conductive spacer, which simplifies the connection between said switch and the support of said switch;
said switch has a single connecting member configured to cooperate with an associated connecting area of the support of said switch;
the spacer is formed by a glue, so that said switch can be placed simply and quickly on the support of said switch;
the spacer has an annular shape, enabling the compression volume to be increased, which improves the haptic feedback;
said switch has at least one communication opening between a first compression chamber defined inside said dome and said disk and the outside of the first compression chamber;
the spacer defines with said disk a second compression chamber and said communication opening is formed on said disk so that the first compression chamber communicates with the second compression chamber;
said communication opening is formed on said insulator;
said communication opening is formed on said dome;
said switch includes an actuating surface formed on said dome to protect said switch and guarantee good activation of said switch;
said switch includes a covering provided with an actuating surface and disposed on said dome to protect said switch and guarantee good activation of said switch;
the actuating surface is produced in the form of a protuberance;
the actuating surface is produced in the form of a depression;
said dome and said disk are metal to assure electrical contact when said dome and said disk are brought into contact by activating said switch;
said dome and said disk are produced in plastic material and have respective conductive coverings on the facing sides of said dome and said disk to enable electrical contact between said dome and said disk when said switch is activated.

Other features and advantages of the invention will become more clearly apparent on reading the following description given by way of illustrative and nonlimiting example and from the appended drawings, in which:

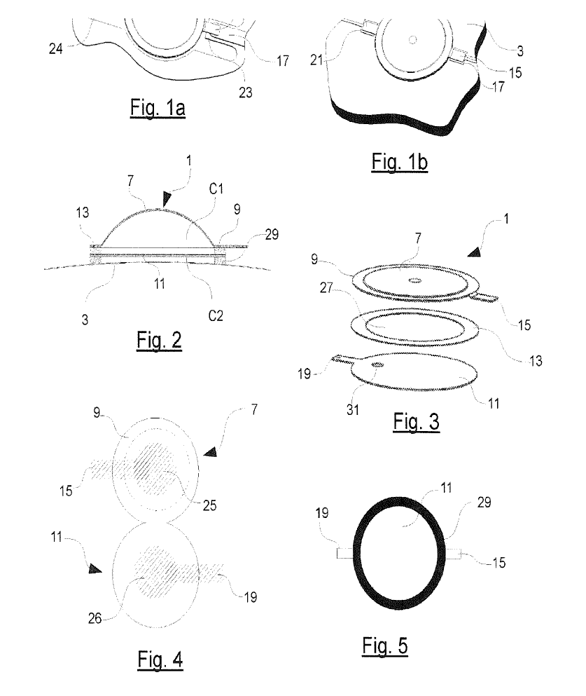

FIG. 1a is a perspective view of part of a thin printed circuit provided with a touch-sensitive switch,

FIG. 1b is a perspective view of part of a thin printed circuit and a touch-sensitive switch mounted on the surface of the printed circuit,

FIG. 2 is a view in section of the touch-sensitive switch of a first embodiment,

FIG. 3 is an exploded view of the touch-sensitive switch,

FIG. 4 shows diagrammatically the dome and the disk of the touch-sensitive switch made from plastic material before assembly,

FIG. 5 is a view of the touch-sensitive switch from below,

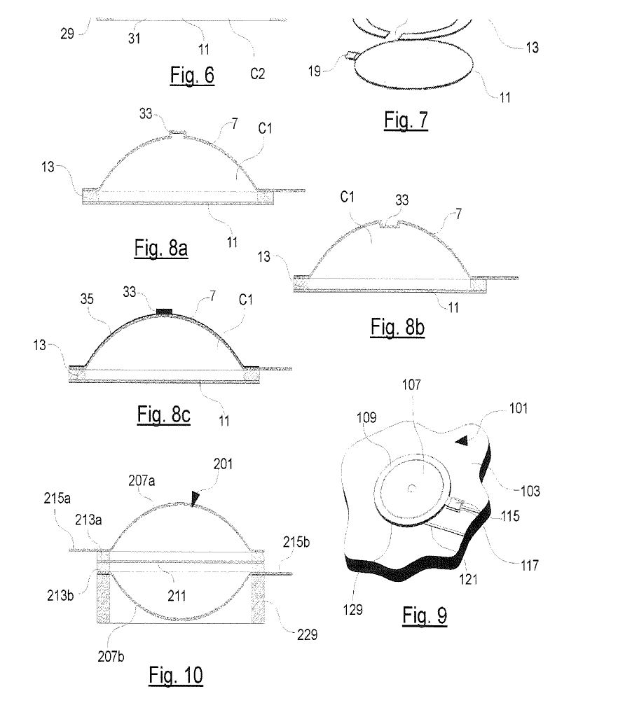

FIG. 6 is a view in section of a touch-sensitive switch having a communication opening on the disk,

FIG. 7 is an exploded view of a touch-sensitive switch having a communication opening on the insulator,

FIG. 8a is a view in section of a touch-sensitive switch having an actuating surface in the form of a protuberance on the dome,

FIG. 8b is a view in section of a touch-sensitive switch having an actuating surface in the form of a depression on the dome,

FIG. 8c is a view in section of a touch-sensitive switch having a covering provided with an actuating surface and disposed on the dome,

FIG. 9 is a perspective view of part of a thin printed circuit and a touch-sensitive switch of a second embodiment mounted on the surface of the printed circuit, and

FIG. 10 is a view in section of a touch-sensitive switch of a third embodiment.

In these figures, identical elements carry the same references.

Elements from FIG. 9, respectively FIG. 10, corresponding to elements from FIGS. 1a to 8c carry the same references preceded by the hundreds digit 1, respectively the hundreds digit 2. These elements will therefore not be described again.

Moreover, in some figures the dimensions of the touch-sensitive switch have been represented in a diagrammatic and exaggerated manner for greater clarity and do not represent the actual dimensions.

FIGS. 1a to 2 show a touch-sensitive switch 1 of the invention mounted on a thin printed circuit 3, i.e. one having a small thickness (of the order of one tenth of a millimeter) , for example of a microchip card. This printed circuit 3 may be a relatively flexible circuit. Here flexible means the property of partially or totally losing and regaining its volume or its shape after compression.

In FIG. 1a, such a switch 1 is shown mounted in a housing 5, having a circular opening for example, of the printed circuit 3. This switch 1 is designed to be activated by pressing on each side of the switch 1, so as to “pinch” the switch 1.

This switch 1 may be surrounded by protective walls disposed facing the dome 7 and the disk 11. These protective layers are flexible to enable activation of the switch 1 by pinching it between two fingers, for example.

FIG. 1b represents an alternative in which the switch 1 is mounted on the surface of the circuit 3, being a surface-mount component (SMC). In this example, the circuit 3 may also be relatively flexible.

Referring to FIGS. 2 and 3, the switch 1 comprises:
a dome 7 having a slight curvature and a continuous circular peripheral part 9,
a flat disk 11 with no curvature, and
an annular insulator 13 disposed between the dome 7 and the disk 11.

The diameter of the dome 7 and the disk 11 is 8 mm, for example. Diameters in the range 4 to 20 mm may be used instead for the dome 7 and the disk 11.

The dome 7 and the disk 11 may have a thickness of a few tens of micrometers.

Such a thin switch 1 may easily be surrounded by a sealing gel, for example, to provide a seal in a simple manner with increase in overall size.

Furthermore, the interior space between the dome 7 and the disk 11 defines a first compression chamber C1 enabling haptic feedback when the switch 1 is activated.

In a first embodiment, the dome 7 has a connecting member 15, here a connecting lug 15 that projects radially from its periphery 9 so as to be in contact with an associated connecting area 17 of the printed circuit 3 (FIGS. 1a to 3).

Similarly, the disk 11 has a connecting member 19, here a connecting lug 19 that projects radially from the disk 11 so as to be in contact with an associated connecting area 21 of the printed circuit 3.

To this end, the printed circuit 3 includes tracks that form the connecting areas 17 and 21 disposed on respective opposite sides of the switch 1.

In the first embodiment shown, the connecting members 15 and 19 are substantially aligned. Alternatively the connecting members 15 and 19 may form a predetermined angle.

In the figure la example, these connecting areas 17 and 21 are formed on tongues 23, 24 disposed around the circular opening of the housing 5.

The connecting members 15 and 19 may be soldered to and thus in contact with the connecting areas 17 and 21, respectively. In this case, the connecting members 15 and 19 include a hole (not shown), for example, for accommodating solder.

Alternatively, the connecting members 15 and 19 may be crimped to the connecting areas 17 and 21. To this end, there may be provision for the connecting members 15 and 19 to have respective pins adapted to pierce the connecting areas 17 and 21 and to be crimped onto these connecting areas 17 and 21, for example by means of a specific crimping tool.

Another alternative is to provide conductive glue on the connecting members 15 and 19 for faster fitting and connection, notably if the switch 1 is placed by a “pick and place” machine.

There could further be provision for the connecting members 15 and 19 to have terminations of tubular general shape complementary to a connecting cable connected to the printed circuit 3.

Moreover, to provide electrical contact between the dome 7 and the disk 11, the latter are conductive members of the switch 1. To this end, the dome 7 and the disk 11 are made of metal.

Alternatively, the dome 7 and the disk 11 are made of plastic material and have a conductive covering.

FIG. 4 shows a different embodiment. In this embodiment, tracks 25 and 26 are screen-printed onto a polycarbonate or polyethylene terephthalate (PET) film, for example using a conductive ink. There may of course be provision for depositing the tracks 25, 26 on the film by means of inkjets or for laminating the tracks 25, 26 onto the film.

A figure-of-eight shape is then cut out with the first loop of the eight forming the dome 7 of the switch and the second loop of the eight forming the flat disk 11 of the switch.

On the one hand, a dome shape is thermoformed to produce the dome 7 of the switch 1 using a mold heated to 150° C., for example, with a connecting member 15 connected to the track 25 and on the other hand a flat disk shape is formed to produce the disk 11 of the switch 1 with a connecting member 17 connected to the track 26.

The tracks 25 and 26 then form a conductive covering of the facing sides of the dome 7 and the disk 11. When the switch is activated and these sides are brought into contact, electrical contact is then established between the dome 7 and the disk 11.

The dome 7 and the disk 11 are then bent and assembled with the insulator 13 disposed between them, for example by gluing.

Referring again to FIG. 3, the insulator 13 has a central opening 27 large enough so that when pressure is exerted by pinching the switch 1 or by pressing on the switch 1 the summit of the dome 7 and the disk 11 are moved toward each other via this opening 27 and brought into electrical contact. When the switch 1 is released, it returns to the rest position in which the dome 7 and the disk 11 are at a distance so that there is no longer any electrical contact between the dome 7 and the disk 11.

The travel between this rest position and the active position obtained by contact between the dome 7 and the disk 11 is of the order of 0.17 mm.

The insulator 13 may be formed by a ring of insulative glue placed between the dome 7 and the disk 11, with a sufficient thickness to assure the insulation, with the result that the total thickness of the switch is of the order of 0.4 mm.

A non-conductive spacer 29 may further be provided, disposed between the disk 11 and the printed circuit 3 (FIG. 2). The spacer 29 then defines with the disk 11 a second compression chamber C2.

This spacer 29 may be a flexible spacer.

This spacer 29 is formed of glue, for example, for faster placement of the switch 1 on the printed circuit 3 and also to provide a sealing function.

In the example shown in FIGS. 2, 5, 6 and 8a to 8c, the spacer 29 has an annular shape. This annular shape of the spacer 29 enables the compression volume of the switch 1 to be increased and thus the haptic feedback to be improved. Other shapes for the spacer 29 may be envisaged.

In the embodiment shown in FIG. 2, there is no communication between the space inside the switch 1 between the dome 7 and the disk 11 and the space outside the switch 1. The inside space and the outside space being at the same pressure, to enable operation of the switch 1, the latter may be produced in a vacuum. To this end the switch 1 may be assembled in the active position in which the dome 7 and the disk 11 are in contact.

As before, once the switch 1 has been mounted and released, it returns to the rest position in which the dome 7 and the disk 11 are at a distance from each other.

A vacuum switch 1 may equally be produced by assembling the dome 7 and the disk 11 in a vacuum enclosure.

In an alternative shown in FIGS. 3 and 6, the space inside the switch 1 communicates with the space outside the switch 1 via a communication opening formed for example by a hole 31 in the disk 11 so that the first compression chamber C1 communicates with the second compression chamber C2 or, in a variant that is not shown, formed on the dome 7.

In another alternative shown in FIG. 7, the communication opening is formed by a passage 32 on the insulator 13, preferably inclined relative to a radial direction.

There could further be provision for the inside space to contain air or a gas at atmospheric pressure or a higher pressure and not to be connected to the outside. Accordingly, on closure of the switch, the compression of the gas placed inside increases the necessary pressure force.

The switch 1 may further include an actuating surface 33 to improve the haptic feedback (see FIGS. 8a to 8c).

This actuating surface 33 may be formed directly on the dome 7 (FIGS. 8a, 8b) or alternately on a covering 35 of the switch 1, for example a silicone covering disposed on the dome 7 (FIG. 8c). This covering 35 also provides a sealing function.

Moreover, the actuating surface 33 may form a protuberance or a nipple (FIGS. 8a, 8c) or alternatively a depression (FIG. 8b).

A plurality of switches 1 formed in this way may be package in strip form to improve further the speed of placement of the switches 1 on the printed circuits 3. By way of example, the switches 1 are retained on a silicone film by an adhesive and the silicone film includes guide holes.

A second embodiment shown in FIG. 9 differs from the first embodiment in that the spacer 129 is conductive.

In this second embodiment, only the dome 107 includes a connecting member 115, here a connecting lug 115 that projects radially from its periphery 109 to come into contact with an associated connecting area 117 of the printed circuit 103.

It is no longer necessary for the disk to include a connecting member adapted to be in contact with an associated connecting area 121 of the printed circuit 103.

To the contrary, the spacer 129 connects the disk to the connecting area 121 without necessitating soldering or any other kind of connection.

A third embodiment shown in FIG. 10 differs from the first and second embodiments in that the switch 201 includes a plurality of layers. The switch 201 includes:
a first dome 207a and a second dome 207b each having a slight curvature,
a flat disk 211 with no curvature,
a first insulator 213a disposed between the disk 211 and the first dome 207a, and
a second insulator 213b disposed between the disk 211 and the second dome 207b.

In a similar manner to the first embodiment described above, the switch 201 may have an actuating surface on one of the domes 207a or 207b or on both domes 207a and 207b.

Moreover, the switch 201 may include a spacer 229 facing the second dome 207b and intended to be disposed on the printed circuit.

This spacer 229 may be non-conductive as in the first embodiment or conductive as in the second embodiment.

In the latter case where the spacer 229 is conductive, only the first dome 207a and the disk 211 have connecting members that connect to associated connecting areas of the printed circuit, the second dome 207b being connected to the printed circuit via the conductive spacer 229.

Using such a switch 201 with a plurality of layers, here two layers by virtue of the two domes 207a, 207b, enables an increase in the pressure force necessary to activate the switch 201 or to perform a succession of activations.

For example, when the first switch 201 is subject to a first pressure the first dome 207a is brought into contact with the disk 211 and when the switch 201 is subjected to a second pressure greater than the first pressure it is the second dome 207b that is brought into contact with the flat disk 211.

Thus a plurality of states may be defined for the switch 201, here three states:
a first state in which the switch 201 is in a rest position with the domes 207a and 207b at a distance from the disk 211,
a second state in which the first dome 207a is brought into contact with the disk 211 to command a first function, and
a third state in which the second dome 207b is brought into contact with the disk 211 to command a second function.

Of course, a switch 201 may be provided with more than two layers by virtue of a plurality of domes 207a, 207b and a plurality of disks 211.

It is thus clear that a thin switch of this kind may be easily integrated into a printed circuit, for example of a thin card, such as a bank card, whilst ensuring tactile feedback to the user when the switch is activated.

Another application example is an intelligent garment, i.e. a garment incorporating such a switch, for example for controlling a portable media player.

Such a thin switch is also very suitable for producing a discreet, i.e. practically invisible, key.

Moreover, such a switch may replace a conventional touch-sensitive switch (“tact switch”).

1-18. (canceled)

19. A tactile effect switch comprising:
at least one dome;
at least one disc; and
at least one insulator disposed between said at least one dome and said at least one disk, such that peripheral portions of said at least one dome and said at least one disk are each in contact with a face of said insulator and on opposite sides of said insulator, said insulator having a central orifice so as to allow contact between said at least one dome and said at least one disk when subjected to a force of mutual approach.

20. The switch according to claim 19, further comprising a spacer disposed between said switch and a support of said switch.

21. The switch according to claim 20, wherein said spacer is provided as an insulating spacer.

22. The switch according to claim 21 further comprising two connecting members respectively configured to cooperate with a pad associated with said support.

23. The switch according to claim 20, wherein said spacer is provided as a conductive spacer.

24. The switch according to claim 23, further comprising a single connecting member configured to cooperate with an associated bonding pad of said support.

25. The switch of claim 19, wherein said spacer is provided as an adhesive.

26. The switch according to claim 19, wherein said spacer has an annular shape.

27. The switch according to claim 19, further comprising at least one communication port between a first compression chamber defined within said dome and said disk, and outside the first compression chamber.

28. The switch according claim 27 wherein said spacer defines with said disc a second chamber and in that said communication port is formed on said disc so that the first compression chamber communicates with the second chamber.

29. The switch according to claim 27, wherein said communication port is formed on said insulator.

30. The switch according to claim 27, wherein said communication port is formed on said dome.

31. The switch according to claim 19, further comprising an actuating surface formed on said dome.

32. The switch according to claim 19, further comprising a cover provided with an actuating surface and disposed on said dome.

33. The switch according to claim 19, wherein the actuating surface is in the form of a protuberance.

34. The switch according claim 31 wherein the actuating surface is in the form of a recess.

35. The switch of claim 19, wherein said dome and said disk are metallic.

36. The switch according to claim 19, wherein said dome and said disk are made of plastic and each have a conductive cover on receptive faces thereof.
